(19) United States
(12) Patent Application Publication
(10) Pub. No.: US 2008/0119217 A1
(43) Pub. Date: May 22, 2008

(54) PORTABLE COMMUNICATION HAVING ACCIDENTAL KEY PRESS FILTERING

(75) Inventor: Robert A. Coxhill, Horwich (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/560,584

(22) Filed: Nov. 16, 2006

(51) Int. Cl. H04M 1/00

(52) U.S. Cl. 455/550.1

(57) ABSTRACT

A portable communication device is equipped with keypad filter circuitry, which is operable to eliminate or otherwise minimize calls, such as emergency calls and non-emergency calls, due to accidental or unintentional key press sequences. The keypad filter circuitry receives keypad input, analyzes the received keypad input and determines if the keypad input is accidental or unintentional. If the keypad input is determined to be accidental or unintentional, the portable communication device takes action to prevent initiation of the call and/or unlocking of the keypad.

### TECHNICAL FIELD OF THE INVENTION

The present invention relates generally to portable communication devices, and, more particularly, to a portable communication device and method including accidental key press filtering.

### DESCRIPTION OF RELATED ART

In recent years, portable communication devices, such as mobile phones, personal digital assistants, mobile terminals, etc., continue to grow in popularity. Such various forms of portable communication devices typically include numerous keys in the form of a keypad and/or touch screen, which allow for operation by a user. For example, a mobile phone typically includes a keypad having alphanumeric keys and function keys. A user may enter a telephone number via the alphanumeric keys, and initiate a call by activating a designated “send” key. The user may activate a designated “call end” key, which functions to “hang up” or otherwise disconnect the call. Various other keys may be provided, such as a web browser launch key, a mute key and the like.

When the portable communication device is not in use or is in use in a “hands free” mode, it is relatively common for keys to be pressed at random as the user moves around. Accidental call initiation may lead to unintended expense, excessive battery wear, accidental data loss and potential embarrassment for the device user.

One solution to the problem of inadvertent or accidental calling is to equip the device with a keypad lock feature, which is activated through the device user interface, and typically prevents inadvertent or accidental activation of the device. But device users frequently forget to lock the keypad before putting the device away.

According to most mobile phone standards, the device must support the calling of emergency numbers (911, 112 or the like) even when the keypad is in a locked state. Because digits included in emergency numbers can be entered into a locked device, accidental emergency calls still may be initiated even when the device is in a locked state. These accidental emergency calls are a growing problem that may lead to increased response time or even a failure to respond to an actual emergency. By way of example, British Telecom has reported that its operators answer approximately 22,000 accidental emergency calls each day from mobile telephones.

### SUMMARY

In view of the foregoing, a need exists for a portable communication device that does not suffer from the aforementioned shortcomings related to accidental call initiation. Moreover, a need exists for a portable communication device equipped with accidental key press filtering, which assists in reducing or eliminating accidental calls.

One aspect of the technology relates to a portable communication device including a keypad having a plurality of keys, and a keypad filter circuit operatively coupled to the keypad. The keypad filter circuit receives keypad input, analyzes the received keypad input, and determines if the keypad input is accidental keypad input.

According to another aspect, the keypad filter circuit causes the portable communication device to act on the received keypad input if the keypad input is determined not to be accidental keypad input.

According to another aspect, the portable communication device initiates a call according to the keypad input if the keypad input is determined not to be accidental keypad input.

According to another aspect, the keypad filter circuit causes the portable communication device to ignore the keypad input if the keypad input is determined to be accidental keypad input.

According to another aspect, the keypad filter circuit causes the portable communication device to transmit a call confirmation prompt to a user of the portable communication device if the keypad input is determined to be accidental keypad input.

According to another aspect, the portable communication device initiates a call according to the keypad input if a call confirmation is received.

According to another aspect, the portable communication device ignores the keypad input if no call confirmation is received.

According to another aspect, the keypad filter causes the portable communication device to lock the keypad if the keypad input is determined to be accidental keypad input.

According to another aspect, the portable communication device is a mobile telephone.

Another aspect of the technology relates to a method of preventing accidental call initiation in a portable communication device. The method includes receiving keypad input, analyzing the keypad input, and determining if the keypad input is accidental keypad input.

According to another aspect, if the keypad input is determined not to be accidental keypad input, the method acting upon the keypad input.

According to another aspect, if the keypad input is determined to be accidental keypad input, the method includes ignoring the keypad input.

According to another aspect, if the keypad input is determined to be accidental keypad input, the method includes transmitting a call confirmation prompt to a user of the portable communication device.

According to another aspect, if a call confirmation is received, the method includes initiating a call according to the keypad input.

According to another aspect, if no call confirmation is received, the method includes ignoring the keypad input.

According to another aspect, if the keypad input is determined to be accidental keypad input, the method includes locking the keypad of the portable communication device.

According to another aspect, if the keypad input is determined to be accidental keypad input, the method includes updating criteria for determining if the keypad input is accidental keypad input based on the received accidental keypad input.

According to another aspect, determining if the keypad input is accidental keypad input includes analyzing the total number of key presses within the keypad input.

According to another aspect, determining if the keypad input is accidental keypad input includes determining whether a plurality of the key presses are indicative of a number or a portion of a number stored within a memory of the portable communication device.

According to another aspect, determining if the keypad input is accidental keypad input includes determining if the keypad input includes a recognizable sequence, and analyzing the keypad input before and/or after the recognizable sequence.

According to another aspect, determining if the keypad input is accidental keypad input includes analyzing timing between key presses of the keypad input.

Another aspect of the technology relates to a program stored on a machine-readable medium, the program being suitable for use in a portable communication device, wherein when the program is loaded in memory in the portable communication device and executed causes the portable communication device to receive signals indicative of keypad input, analyze the received signals, and determine whether the keypad input is accidental keypad input.

According to another aspect, a portable communication device includes a memory and a controller that executes an application program within the memory. When executed, the application program causes the portable communication device to receive signals indicative of keypad input, analyze the received signals, and determine whether the keypad input is accidental keypad input.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a mobile telephone as an exemplary portable communication device;

FIG. 2 is a diagrammatic illustration of a portable communication device in accordance with aspects of the present technology;

FIG. 3 is a flow chart or functional diagram representing a method of preventing accidental call initiation in a portable communication device;

FIG. 4 is a flow chart or functional diagram representing a method of preventing accidental call initiation in a portable communication device in accordance with another aspect of the disclosed technology; and

FIG. 5 is a flow chart or functional diagram representing a method of preventing accidental call initiation in a portable communication device in accordance with another aspect of the disclosed technology.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “portable communication device” includes portable radio communication equipment. The term “portable radio communication equipment,” which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment having a keypad or data entry module for communication initiation.

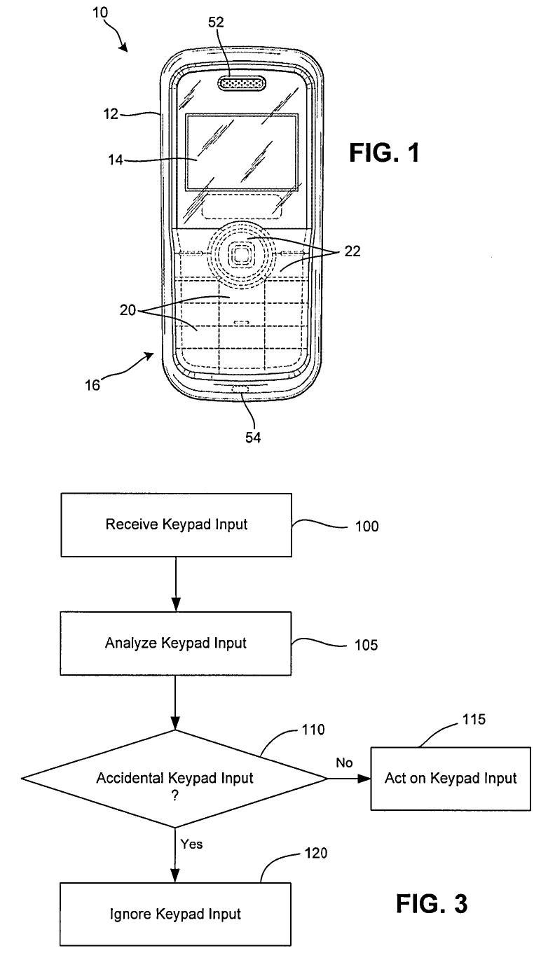

Referring initially to FIG. 1, an exemplary embodiment of a portable communication device 10 (e.g., a mobile phone, mobile terminal or the like) is depicted. As is described more fully below, the portable communication device 10 includes keypad filter circuitry that functions to eliminate or otherwise minimize call initiation due to accidental or unintentional keypad input by a user of the portable communication device. The keypad filter circuitry may be implemented via an application program, code or logic routine that is executed by the portable communication device. The portable communication device 10 is equipped to prevent or otherwise minimize accidental call initiation via unintentional dialing using the keypad.

The portable communication device in the illustrated embodiments is a mobile telephone, and may be referred to as the mobile telephone 10. As indicated, the description and illustrations of a mobile telephone for the portable communication device are intended to serve as a non-limiting exemplary environment for the inventive concepts described herein. The mobile telephone 10 is shown as having a “brick” or “block” form factor housing 12, but it will be appreciated that other types of housings, such as a clamshell housing or a slide-housing, may be utilized.

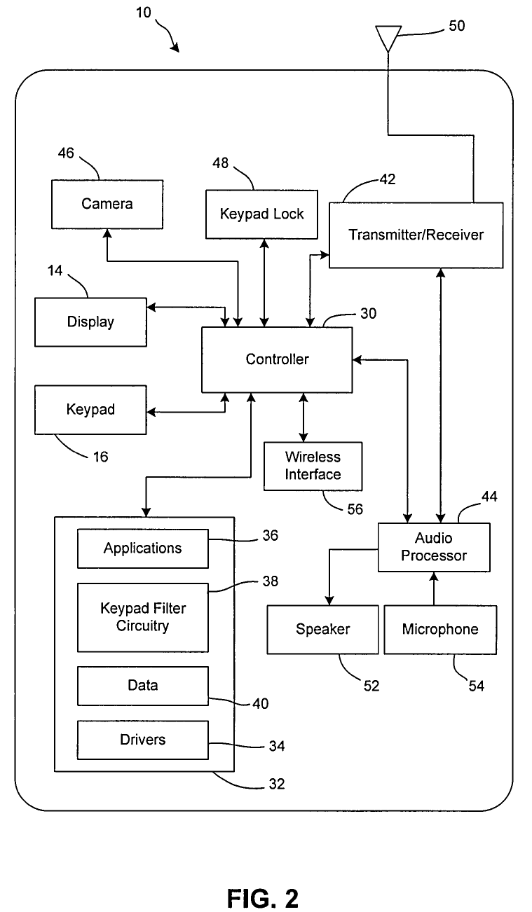

The mobile telephone 10 includes a display 14 and keypad 16. As is conventional, the display 14 displays information to a user, such as operating state, time, telephone numbers, contact information, various navigational menus and the like, which enable the user to utilize the various features of the mobile telephone 10. The display 14 also may be used to visually display content received by the mobile telephone 10 and/or retrieved from a memory 32 (FIG. 2) of the mobile telephone 10.

Similarly, the keypad 16 may be conventional in form and/or operation in that it provides for or otherwise facilitates a variety of user operations. For example, the keypad 16 typically includes alphanumeric keys 20 for facilitating entry of alphanumeric information, such as telephone numbers, phone lists, contact information, electronic mail messages, notes and the like. The keypad may include alphanumeric keys corresponding to numerals zero through nine (similar to a typical landline telephone) or the keypad may be configured as a “QWERTY” keypad having keys for each letter of the alphabet. It will be appreciated that aspects of the herein described technology are applicable to any keypad configuration. For example, the keypad may include keys that extend to the outer edges of the phone housing with little or no spacing between adjacent keys. Alternatively, the keypad may be configured such that spacing exists between adjacent keys. In other words, the keypad 16 is shown in FIG. 1 for purposes of explaining aspects of the present technology, without limiting the technology to a particular keypad configuration. In addition or alternatively, all or part of the keypad may be embodied as a touch screen associated with the display.

In addition, the keypad 16 typically includes special function keys (depicted generally as function keys or “soft keys” 22), such as a “call send” key for initiating or answering a call, and a “call end” key for ending or “hanging up” a call. Special function keys also may include menu navigation keys, for example, for navigating through a menu displayed on the display to select different telephone functions, profiles, settings, etc., as is conventional. Other keys associated with the mobile telephone may include a volume key, an audio mute key, an on/off power key, a web browser launch key, a camera key and the like. Keys or key-like functionality also may be embodied as a touch screen associated with the display 14.

The mobile telephone 10 includes conventional call circuitry that enables the mobile telephone 10 to establish a call or otherwise exchange signals with a call/calling device, typically another mobile telephone, landline telephone or other electronic device. However, the call/calling device need not be another telephone, but may be some other device, such as an Internet web server, media server or the like. The call circuitry also may be responsible for transmitting text messages that are prepared by the user.

FIG. 2 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, including a keypad filter application program (also referred to as keypad filter circuitry 38 or simply as a keypad filter circuit), and application program data 40 (e.g., data associated with the keypad filter circuitry). The I/O device drivers include software routines that are accessed through the controller 30 (or by an operating system (not shown) stored in memory 32) by the application programs, including the keypad filter circuitry 38, to communicate with devices such as the keypad 16, the display 14 and other input/output ports.

The application programs, including the keypad filter circuitry, comprise programs that implement various features of the portable communication device 10, such as voice calls, e-mail, Internet access, contact manager and the like. As is described more fully below, the keypad filter circuit 38 comprises a program, circuitry, logic routine or code that enables the portable communication device to analyze keypad input, to determine whether the keypad input is accidental, and to take action to prevent or otherwise minimize call or communication session initiation based on accidental keypad input.

A person having ordinary skill in the art of computer programming and/or circuit design, and specifically in applications programming and/or circuit design for mobile phones, will consider it obvious in view of the description provided herein how to program a mobile phone to operate and carry out the functions described herein with respect to keypad filter circuitry 38 (and any interfacing between the keypad filter circuitry 38 and other application programs (e.g., messaging application programs, media application programs, keypad locking programs and the like). Accordingly, details as to the specific programming code have been left out. Also, while the keypad filter functionality is carried out via the controller 30 and keypad filter circuitry 38 (alone or in conjunction with other application programs) in memory 32 in accordance with inventive aspects, such function also could be carried out via dedicated hardware, firmware, software or combinations thereof without departing from the scope of the present invention.

With continued reference to FIG. 2, the controller 30 interfaces with the aforementioned display 14 and keypad 16 (and any other user interface device), a transmitter/receiver 42 (often referred to as a transceiver), audio processing circuitry, such as an audio processor 44, and a position determination element (not shown), such as a global positioning system (GPS) receiver. The portable communication device 10 may include a camera 46 that captures digital pictures and/or video. Image and/or video files corresponding to the pictures and/or video may be stored in memory 32. The portable communication device may include keypad lock circuitry 48, which serves to lock the keypad 16 upon appropriate activation (e.g., a code or other key press sequence). It will be appreciated that typical keypad lock circuitry (e.g., keypad lock circuitry in compliance with the Global System for Mobile Communications (GSM) standard) serves to ignore any key press input that is not a part of a recognized emergency number (e.g., 911, 112 or the like).

An antenna 50 is coupled to the transmitter/receiver 42 such that the transmitter/receiver 42 transmits and receives signals via antenna 50, as is conventional. The portable communication device includes an audio processor 44 for processing the audio signals transmitted by and received from the transmitter/receiver. Coupled to the audio processor 44 are a speaker 52 and microphone 54, which enable a user to listen and speak via the portable communication device. Audio data may be passed to the audio processor 44 for playback to the user. The audio data may include, for example, audio data from an audio file stored in the memory 32 and retrieved by the controller 30. The audio processor 44 may include any appropriate buffers, decoders, amplifiers and the like.

The portable communication device also may include one or more local wireless interfaces (indicated generally as wireless interface 56), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device.

While for purposes of simplicity of explanation, the flow charts or diagrams in FIGS. 3-5 include a series of steps or functional blocks that represent one or more aspects of the relevant operation of the keypad filter circuit 38 within portable communication device 10 (alone or in conjunction with other portions, circuits, application programs or modules of the portable communication device). It is to be understood and appreciated that aspects of the technology described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIGS. 3-5, which are implemented on a portable communication device, relate to detecting and preventing or otherwise minimizing calls (e.g., emergency calls, non-emergency calls, voice or data communication sessions, web browsing sessions or the like) due to accidental or unintentional key press sequences. Turning now to FIG. 3, a method of preventing or otherwise minimizing accidental call initiation begins at functional block 100 where keypad input (or signals from the keypad representative or indicative of keypad input) are received (e.g., by keypad filter circuitry). The received keypad input may include any number of key presses received through the keypad of the portable communication device. For example, in the case of an intentional call being made by a user of the portable communication device, the received keypad input may include the dialing of a number of digits to initiate a phone call to a third party. Alternatively, the keypad input may include a number of key presses, which actually result from accidental key presses (e.g., key presses performed or otherwise registered while the portable communication device is in the user's pocket or in the user's purse). It will be appreciated that aspects of the method described herein may be performed while the portable communication device is in a keypad locked state, as well as when the keypad is in an unlocked state. For example, the keypad may become unlocked due to random motion that causes the keypad unlock sequence to be entered. Alternatively, the portable communication device may be locked, but an emergency sequence may be entered due to unintentional, random motion.

At functional block 105, the keypad input is analyzed (e.g., by the keypad filter circuitry). Analysis of the keypad input may include a number of diagnostic operations performed to determine whether the received keypad input is accidental or unintentional keypad input, as opposed to intentional keypad input (functional block 110). For example, the keypad filter circuitry may determine if the received keypad input includes a recognizable sequence of digits or alphanumeric characters. In addition or alternatively, the keypad filter circuit may analyze keypad input that occurs before and/or after the recognizable sequence. For example, if the keypad filter circuit receives the following sequence of digits, 7-7-7-9-1-1-SEND-7-7-7, that is, the sequence, 9-1-1-SEND surrounded by a plurality of key presses of the digit seven, the keypad filter circuitry may recognize that the emergency sequence 9-1-1 is “buried” among a number of key presses of the digit seven. In this exemplary instance, the keypad filter circuitry may determine that the received keypad input appears to be accidental input in that the characters before and/or after the recognizable sequence seem to be random digits.

In addition or alternatively, analyzing the keypad input may include an analysis of timing between the key presses that make up the received keypad input. For example, if the received keypad input is 7-7-9-1-1-SEND, where several seconds or tens of seconds lapse between adjacent key presses making up the keypad input, then the keypad filter circuit may determine that the received keypad input is likely to be accidental keypad input based on the extended period of time between individual key presses making up the received keypad input. Another diagnostic technique that may be used to analyze the received keypad input is an analysis or recognition of the number of digits or key presses within the received keypad input. For example, if the received keypad input is made up of only three key presses, which also happen to be the three digits used to initiate an emergency call (e.g., 911, 112 or the like), then the keypad filter circuitry may determine that an emergency call is being made intentionally by the user of the portable communication device. Also, if the keypad input is made up of ten digits, beginning with a recognized area code, then the keypad filter circuit may determine that it is likely that the keypad input is intentional and not accidental keypad input.

At functional block 110, the portable communication device determines whether or not the analyzed keypad input is accidental keypad input or intentional keypad input based on one or more of the above-described exemplary diagnostic techniques for analyzing the keypad input (functional block 105). If the portable communication device determines that the received keypad input is intentional keypad input, then the portable communication device may act on the received keypad input (functional block 115), for example, by initiating a call or other data communication session based on the received keypad input. Alternatively, if the portable communication device determines that the received keypad input is accidental keypad input (functional block 110), then the portable communication device may ignore or otherwise disregard the received keypad input (functional block 120). It will be appreciated that ignoring or otherwise disregarding the received keypad input may include the portable communication device canceling any functions or processes that were initiated during analysis of the keypad input (for example, before the keypad input is identified as being accidental.)

It will be appreciated that aspects of the methods described with respect to FIG. 3-5, may be implemented on a portable communication device that is in a keypad locked state, as well as a keypad that is in an unlocked state. For example, the portable communication device may be configured to specifically prevent accidental emergency calls by only filtering received keypad input when the device is in a keypad locked state. Alternatively, the portable communication device may be configured to prevent any accidental call by filtering received keypad input regardless of whether the keypad is in a locked state. Further, the portable communication device may be configured to prevent an unlocking code from being entered accidentally.

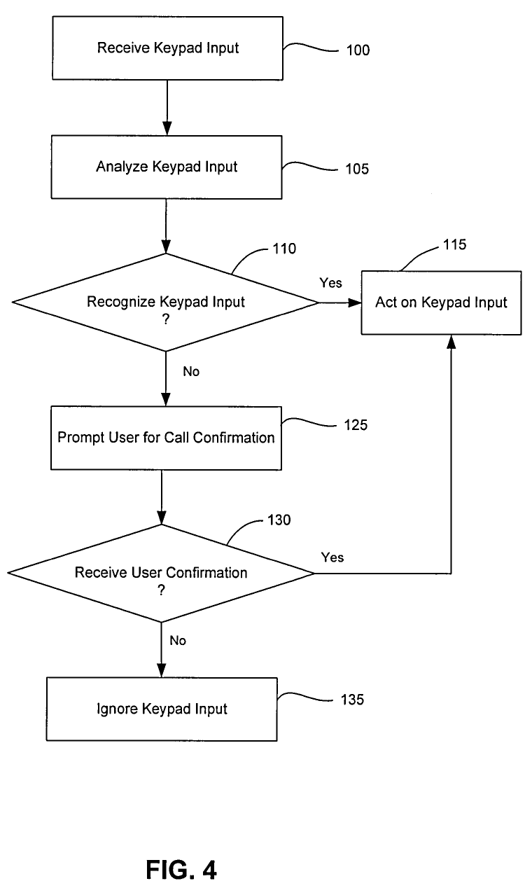

Referring now to FIG. 4, an alternative embodiment of a method of preventing or otherwise minimizing accidental call initiation in a portable communication device begins at functional block 100, where the portable communication device receives keypad input. As is described above with respect to FIG. 3, the received keypad input typically includes a sequence of key presses representative or otherwise indicative of a sequence of numbers or letters. As is described above, the portable communication device (e.g., through the keypad filter circuitry) analyzes the received keypad input (functional block 105) according to one or more diagnostic procedures aimed at determining whether the received keypad input is accidental keypad input or intentional keypad input.

As is described above, at functional block 110, the portable communication device determines whether or not the received keypad input is recognized keypad input, and if the keypad input is determined to be recognized or intentional keypad input, the portable communication device acts on the received keypad input (functional block 115), for example, by initiating a call or other data or voice communication session based on the received keypad input.

At functional block 125, if the portable communication device determines that the keypad input is not recognized keypad input, the portable communication device may prompt the user of the device for call confirmation. For example, the portable communication device may provide a warning beep, a vibration, or other auditory or tactile indication prompting the user for confirmation that a call should be initiated. Alternatively, the portable communication device may display a message on the device display asking or otherwise prompting the user whether it is intended for a call to be initiated. At functional block 130, if the portable communication device receives confirmation from the device user that the received keypad input was not accidental, (e.g., it is intended for a call to be initiated) the portable communication device may initiate a call (functional block 115) according to the received keypad input. Alternatively, if the portable communication device fails to receive user confirmation in response to the prompt for user confirmation (e.g., within a given time period) the portable communication device may ignore the received keypad input (functional block 135). In an alternative embodiment, the portable communication device may choose to lock an unlocked keypad if the portable communication device fails to receive user confirmation in response to a prompt for user confirmation.

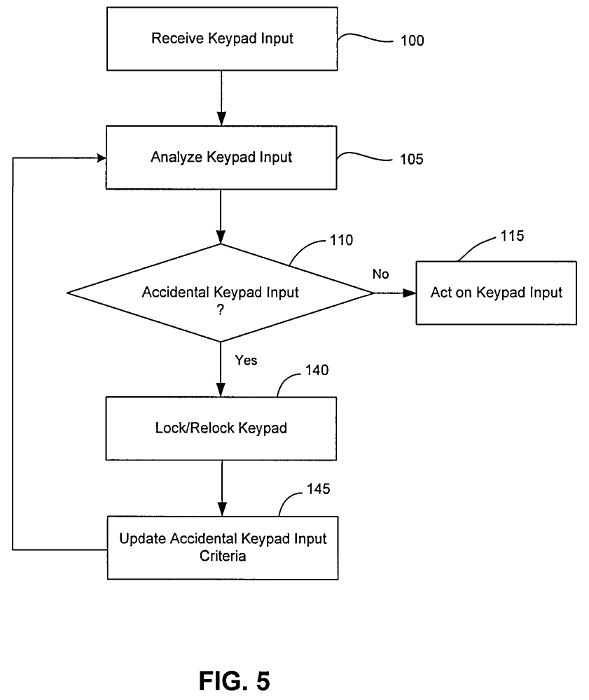

Referring now to FIG. 5, an alternative embodiment of a method of preventing or otherwise minimizing accidental call initiation in a portable communication device begins at functional block 100 where the portable communication device receives keypad input. As is discussed above, the keypad input may include any sequence or sequences of key presses. The portable communication device analyzes the keypad input (functional block 105) according to one or more diagnostic procedures, including, but not limited to presence of a recognizable sequence, number of key presses before and/or after a recognizable sequence, timing between key presses within a sequence, whether the keypad is in a locked state, and the like, and determines whether or not the received keypad input is accidental keypad input (110). As is described above, if the portable communication device determines that the received keypad input is not accidental keypad input, then the portable communication device will act on the received keypad input (functional block 115), for example, initiating a call or other communication session according to the received keypad input.

At functional block 140, if the portable communication device determines that the received keypad input, is accidental keypad input, then the portable communication device may automatically lock or relock the keypad. It will be appreciated that locking or relocking of the keypad serves to prevent call initiation for all calls other than emergency calls (e.g., calls to 911, 112, or another recognized emergency number).

At functional block 145, if the portable communication device determines that the received keypad input is accidental keypad input, the portable communication device (e.g., via the keypad filter circuitry) may update the criteria or diagnostics for determining what constitutes accidental keypad input. For example, if the received keypad input seems to include a repeated numeric sequence that is determined to be accidental keypad input, the diagnostic portion of the keypad filter circuitry may be updated to automatically disqualify the sequence, which has previously been recognized as being accidental keypad input. Also, the keypad filter circuitry may impose more strict criteria for unlocking the device following an automatic lock or relock. Other criteria also may be changed (e.g., made to be more strict), such as setting a threshold (e.g., a reduced threshold) for a maximum number of key press characters before and/or after a recognized sequence, setting a threshold for an acceptable amount of time between key presses, and the like.

This dynamic determination of what constitutes accidental keypad input may take into account a number of different models or factors based on and constantly updated based on received keypad input. For example, one model may take into account a particular location for a particular key within the keypad, and may give signatures to a physical makeup of a device. For example, in an embodiment where the keypad extends to the outer edges of the device housing, a key press prediction model may recognize that accidental key presses may be more prevalent where keys located around the perimeter of the keypad, than for key presses located near the interior of the keypad. This may be especially true in expanded “QWERTY” keypads.

It will be appreciated that aspects of the technology described above also may relate to filtering of key presses that occur using so-called “soft keys,” such as functional and dynamic keys typically found near an upper portion of a keypad. Also, the methodology described above may be applied to filtering keypad input entered via a touch screen on the portable communication device. In addition, other input criteria may be employed while analyzing whether the received keypad input is accidental keypad input. For example, microphone input may be monitored or otherwise sampled to determine whether some indication exists of accidental keypad input versus intentional keypad input. For instance, if the portable communication device is being stored in a user's pocket or a user's purse or briefcase, it may be that the microphone input is relatively muted or random in sound, as opposed to a condition where the user is intentionally entering keypad input to initiate a call. In addition, other sensors or information receivers may be employed to determine the relative position or proximity of the phone to the user. For example, the portable communication device may be employed with one or more proximity sensors, which can function to determine the relative proximity of the phone to the user (e.g., to determine whether the user is holding the phone in his or her hand as opposed to storing the phone in a pocket, purse or a briefcase).

While aspects of the technology have been described with respect to preventing accidental call initiation, it will be appreciated that the foregoing also is applicable to preventing accidental unlocking of the device keypad. For example, if a key press sequence includes a keypad unlocking sequence or code among other keypad input, the device may determine whether the input was accidental, and ignore or automatically relock the keypad upon detection of an accidental keypad unlocking sequence.

In addition, aspects of the keypad input analysis also may be applicable to determining an intentional keypad input made on a locked keypad. For example, a user may forget to unlock the device keypad and enter a recognized phone number. Upon detection of the recognized phone number, the device may automatically unlock the keypad and place the call according to the recognized keypad input.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means” ) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a keypad having a plurality of keys; and
a keypad filter circuit operatively coupled to the keypad, wherein the keypad filter circuit:
receives keypad input;
analyzes the received keypad input; and
determines if the keypad input is accidental keypad input.

2. The portable communication device according to claim 1, wherein the keypad filter circuit causes the portable communication device to act on the received keypad input if the keypad input is determined not to be accidental keypad input.

3. The portable communication device according to claim 1, wherein the portable communication device initiates a call according to the keypad input if the keypad input is determined not to be accidental keypad input.

4. The portable communication device according to claim 1, wherein the keypad filter circuit causes the portable communication device to ignore the keypad input if the keypad input is determined to be accidental keypad input.

5. The portable communication device according to claim 1, wherein the keypad filter circuit causes the portable communication device to transmit a call confirmation prompt to a user of the portable communication device if the keypad input is determined to be accidental keypad input.

6. The portable communication device according to claim 5, wherein the portable communication device initiates a call according to the keypad input if a call confirmation is received.

7. The portable communication device according to claim 6, wherein the portable communication device ignores the keypad input if no call confirmation is received.

8. The portable communication device according to claim 1, wherein the keypad filter causes the portable communication device to lock the keypad if the keypad input is determined to be accidental keypad input.

9. The portable communication device according to claim 1, wherein the portable communication device is a mobile telephone.

10. A method of preventing accidental call initiation in a portable communication device, the method comprising:
receiving keypad input;
analyzing the keypad input; and
determining if the keypad input is accidental keypad input.

11. The method according to claim 10, further comprising:
if the keypad input is determined not to be accidental keypad input, acting upon the keypad input.

12. The method according to claim 11, further comprising:
if the keypad input is determined to be accidental keypad input, ignoring the keypad input.

13. The method according to claim 1 1, further comprising:
if the keypad input is determined to be accidental keypad input, transmitting a call confirmation prompt to a user of the portable communication device.

14. The method according to claim 13, further comprising:
if a call confirmation is received, initiating a call according to the keypad input.

15. The method according to claim 14, further comprising:
if no call confirmation is received, ignoring the keypad input.

16. The method according to claim 11, further comprising:
if the keypad input is determined to be accidental keypad input, locking the keypad of the portable communication device.

17. The method according to claim 11, further comprising:
if the keypad input is determined to be accidental keypad input, updating criteria for determining if the keypad input is accidental keypad input based on the received accidental keypad input.

18. The method according to claim 11, wherein determining if the keypad input is accidental keypad input includes analyzing the total number of key presses within the keypad input.

19. The method according to claim 11, wherein determining if the keypad input is accidental keypad input includes determining whether a plurality of the key presses are indicative of a number or a portion of a number stored within a memory of the portable communication device.

20. The method according to claim 11, wherein determining if the keypad input is accidental keypad input includes:
determining if the keypad input includes a recognizable sequence; and
analyzing the keypad input before and/or after the recognizable sequence.

21. The method according to claim 11, wherein determining if the keypad input is accidental keypad input includes analyzing timing between key presses of the keypad input.

22. A program stored on a machine-readable medium, the program being suitable for use in a portable communication device, wherein when the program is loaded in memory in the portable communication device and executed causes the portable communication device to:
receive signals indicative of keypad input;
analyze the received signals; and
determine whether the keypad input is accidental keypad input.

23. A portable communication device comprising a memory and a controller that executes an application program according to claim 22 within the memory.
